(19) United States
(12) Patent Application Publication
(10) Pub. No.: US 2011/0208574 A1
(43) Pub. Date: Aug. 25, 2011

(54) SYSTEM AND METHOD FOR DELIVERING AND TRANSMITTING MEDIA CONTENT TO AND FROM AN ELECTRONIC KIOSK

(75) Inventors: Jesus Hinojosa, JR., Dallas, TX (US); Amado Crisolfo Coronado, Dallas, TX (US)

(73) Assignee: Mesa Digital, LLC

(21) Appl. No.: 13/016,426

(22) Filed: Jan. 28, 2011

Related U.S. Application Data
(60) Provisional application No. 61/307,527, filed on Feb. 24, 2010.

(51) Int. Cl. G06Q 30/00

(52) U.S. Cl. 705/14.23; 705/26.1

(57) ABSTRACT

A method and system for delivering and transmitting media content with respect to an electronic kiosk. The electronic kiosk can be directly accessed via a portable handheld device in order to select and retrieve the digital media content that is stored electronically in a database associated with the electronic kiosk. The payment with respect to the downloaded media content can be made via a pre-existing online account and/or an electronically readable card associated with an RFID tag. Upon payment the media kiosk releases the media content to the portable handheld device. The media content that has not yet been released for sale can be pre-ordered so that the media content can be purchased and delivered to the customer once the media content becomes available.

### CROSS-REFERENCE TO PROVISIONAL APPLICATION

This nonprovisional patent application claims the benefit under 35 U.S.C. §119(e) of U.S. Provisional Patent Application Ser. No. 61/307,527 filed on Feb. 24, 2010, entitled “System and Method for Delivering and Transmitting Media Content to and From an Electronic Kiosk,” which is hereby incorporated by reference in its entirety.

### TECHNICAL FIELD

Embodiments are generally related to electronic kiosks. Embodiments are also related to on-demand media content delivery systems and methods. Embodiments are additionally related to the transmission of media content with respect to an electronic kiosk.

### BACKGROUND OF THE INVENTION

Media content such as, for example, movies, television programs, videos, music, games and other assets, have been distributed via a variety of channels for a fee-based acquisition. With the technological improvements in electronic multimedia, there is an ongoing and increasing need to facilitate and expedite the process of ordering a media content in venue-specific locations thereby capturing impulse purchases and increasing sales. An electronic kiosk placed at a shopping center, a grocery store or another convenient location can be employed to select and deliver the media content to a customer via a storage medium such as, for example, digital video disc (DVD), video tape, compact disc (CD), software media, and so forth.

Conventional electronic kiosks are not compatible for accessing media content via a portable handheld device such as, for example, a zip drive, a USB device or a mobile communication device and the available choices for acquiring and installing new media contents tend to be limited. Such electronic kiosks only offer for purchase of the media contents that have been released and authorized for sale such as, for example, a DVD rental. Unfortunately, customers may be desirous of ordering the media content that is released but not yet authorized for sale or rental. Currently, there is no way to facilitate users' desires of pre-ordering the media content with respect to the electronic kiosk prior to knowledge of a date of availability and/or release for sale or rental.

Based on the foregoing, it is believed that a need exists for an improved system and method for transmitting and delivering a media content with respect to an electronic kiosk, as described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved media content delivery system and method.

It is another aspect of the disclosed embodiments to provide for an improved method and system for delivering and transmitting digital media content with respect to an electronic kiosk.

It is a further aspect of the disclosed embodiments to provide for an improved method for pre-ordering the digital media content from the electronic kiosk.

The aforementioned aspects and other objectives and advantages can now be achieved as described herein. A method and system for delivering and transmitting media content with respect to an electronic kiosk is disclosed herein. The electronic kiosk can be directly accessed via a portable handheld device (e.g., zip drive, USB device, mobile communication device, etc.) in order to select and retrieve the digital media content that is stored electronically in a database associated with the electronic kiosk. The cost associated with the retrieved media content can be determined and displayed to a customer for review and payment. The payment with respect to the downloaded media content can be made via a pre-existing online account and/or an electronically readable card associated with an RFID tag. Upon payment, the media kiosk releases the media content to the portable handheld device.

The rental media contents obtained from the media kiosk can be automatically deleted from the handheld device and restocked to the kiosk on expiry of a predefined time period. The media content that has not yet been released for sale or rental can be pre-ordered ordered so that the media content can be purchased and delivered to the customer once the media content becomes available. The pre-ordered media content can be redeemed to the customer after expiry of certain time period (e.g., after 3 months when movie released) in order to prevent media piracy. Optional discount can also be provided for early purchase and the media content transmitted ahead of release date.

The electronic media kiosk can be configured in association with a media server that communicates and monitors media operations and updates a media library associated with the media kiosk. The kiosk can display a catalog of the media contents stored in the multimedia library in order to enable the customer to browse, search, and select the media contents. The selected media contents in the media kiosk can be retrieved from the media library or from a remote database associated with the media server. The system can further format, encode, encrypt, and transfer the selected media contents to the handheld device. The system can provide the customer with access to a large number of media contents in a convenient low-cost manner that fully satisfies the customer demand, while enhancing the economic incentives and creating an expanding offering of media contents to the customer.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a data-processing system in which an embodiment may be implemented;

FIG. 2 illustrates a schematic view of a software system including an operating system, application software, and a user interface for carrying out an embodiment;

FIG. 3 illustrates a graphical representation of a network of data-processing systems in which aspects of the disclosed embodiments may be implemented;

FIG. 4 illustrates a block diagram of a media distribution system associated an electronic media kiosk, in accordance with the disclosed embodiments;

FIG. 5 illustrates a detailed block diagram of the media distribution system, accordance with the disclosed embodiments; and

FIG. 6 illustrates a high level flow chart of operation illustrating logical operational steps of a method for delivering and transmitting media content with respect to the electronic media kiosk, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

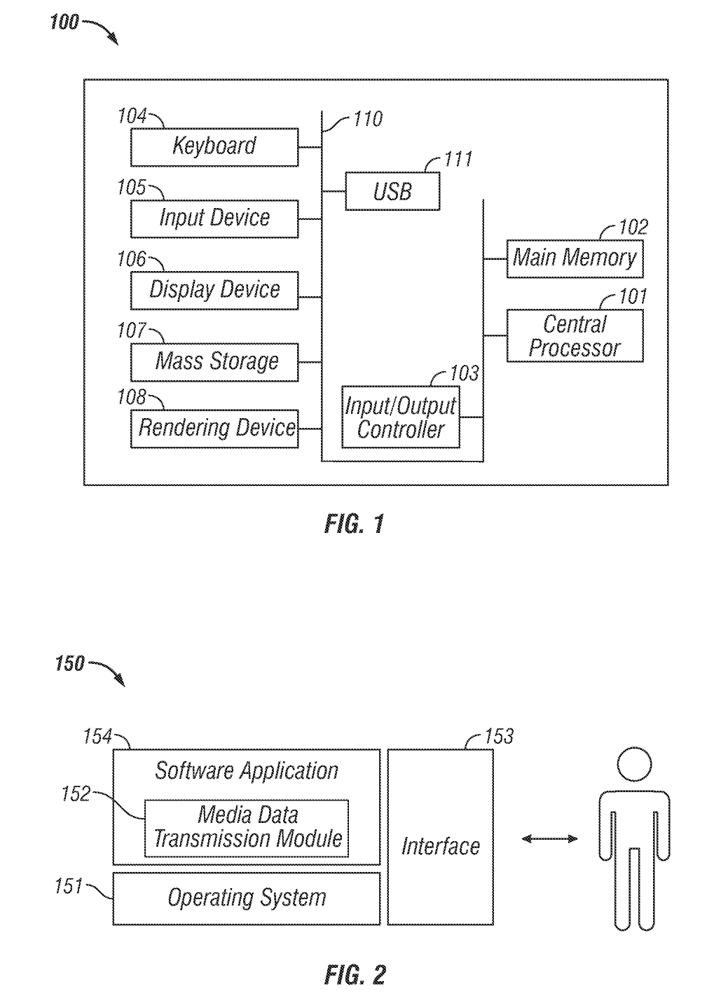

FIGS. 1-3 are provided as exemplary diagrams of data-processing environments in which embodiments of the present invention may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a central processor 101, a main memory 102, an input/output controller 103, a keyboard 104, an input device 105 (e.g., a pointing device such as a mouse, track ball, pen device, etc.), a display device 106, a mass storage 107 (e.g., a hard disk), and a USB (Universal Serial Bus) peripheral connection 111. Additional input/output devices, such as a rendering device 108 (e.g., printer, scanner, fax machine, etc.), for example, may be associated with the data-processing system 100 as desired. As illustrated, the various components of data-processing system 100 can communicate electronically through a system bus 110 or similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 154, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 151 and/or software application 154.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, etc.

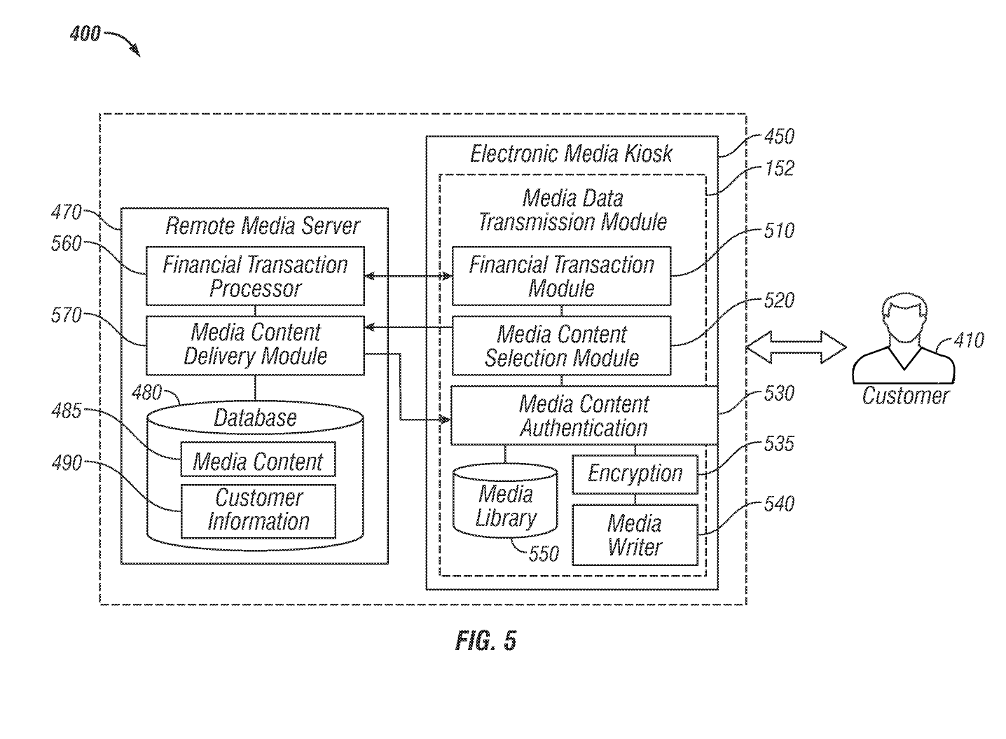

The interface 153, which is preferably a graphical user interface (GUI), can serve to display results, whereupon a user may supply additional inputs or terminate a particular session. In some embodiments, operating system 151 and interface 153 can be implemented in the context of a “Windows” system. It can be appreciated, of course, that other types of systems are possible. For example, rather than a traditional “Windows” system, other operation systems such as, for example, Linux may also be employed with respect to operating system 151 and interface 153. The software application 154 can include, for example, a media data transmission module 152 for delivering and transmitting media contents with respect to an electronic media kiosk, Media data transmission module 152 can include instructions such as those of method 500 discussed herein with respect to FIG. 5.

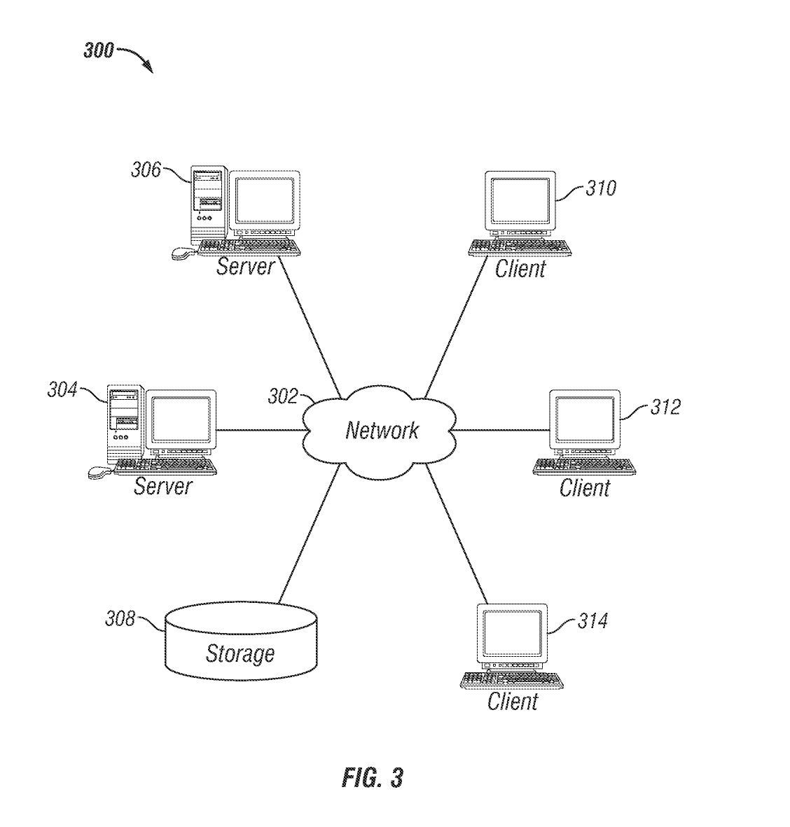

FIG. 3 depicts a graphical representation of a network of data-processing systems in which aspects of the disclosed embodiments may be implemented. Network data-processing system 300 is a network of computers in which embodiments of the present invention may be implemented. Network data-processing system 300 contains network 302, which is the medium used to provide communications links between various devices and computers connected together within network data-processing system 300. Network 302 may include connections such as wire, wireless communication links, or fiber optic cables.

In the depicted example, server 304 and server 306 connect to and communicate with network 302 along with storage unit 308 (e.g. a memory, database, etc). In addition, clients 310, 312, and 314 connect to and communicate with network 302. These clients 310, 312, and 314 may be, for example, personal computers or network computers. Data-processing system 100 depicted in FIG. 1 can be, for example, a client such as client 310, 312, and/or 314. Alternatively, data-processing system 100 can be implemented as a server, such as servers 304 and/or 306, depending upon design considerations,

In the depicted example, server 304 provides data such as boot files, operating system images, and applications to clients 310, 312, and 314. Clients 310, 312, and 314 are clients to server 304 in this example. Network data-processing system 300 may include additional servers, clients, and other devices not shown. Specifically, clients may connect to any member of a network of servers that provide equivalent content.

In the depicted example, network data-processing system 300 is the Internet with network 302 representing a worldwide collection of networks and gateways that use the Transmission Control Protocol/Internet Protocol (TCP/IP) suite of protocols to communicate with one another, At the heart of the Internet is a backbone of high-speed data communication lines between major nodes or host computers consisting of thousands of commercial, government, educational, and other computer systems that route data and messages. Of course, network data-processing system 300 also may be implemented as a number of different types of networks such as, for example, an intranet, a local area network (LAN), or a wide area network (WAN).

FIGS. 1-3 are thus intended as an example and not as an architectural limitation with respect to particular embodiments. Such embodiments, however, are not limited to any particular application or any particular computing or data-processing environment. Instead, those skilled in the art will appreciate that the disclosed system and method may be advantageously applied to a variety of system and application software. Moreover, the present invention may be embodied on a variety of different computing platforms, including Macintosh, UNIX, LINUX, and the like.

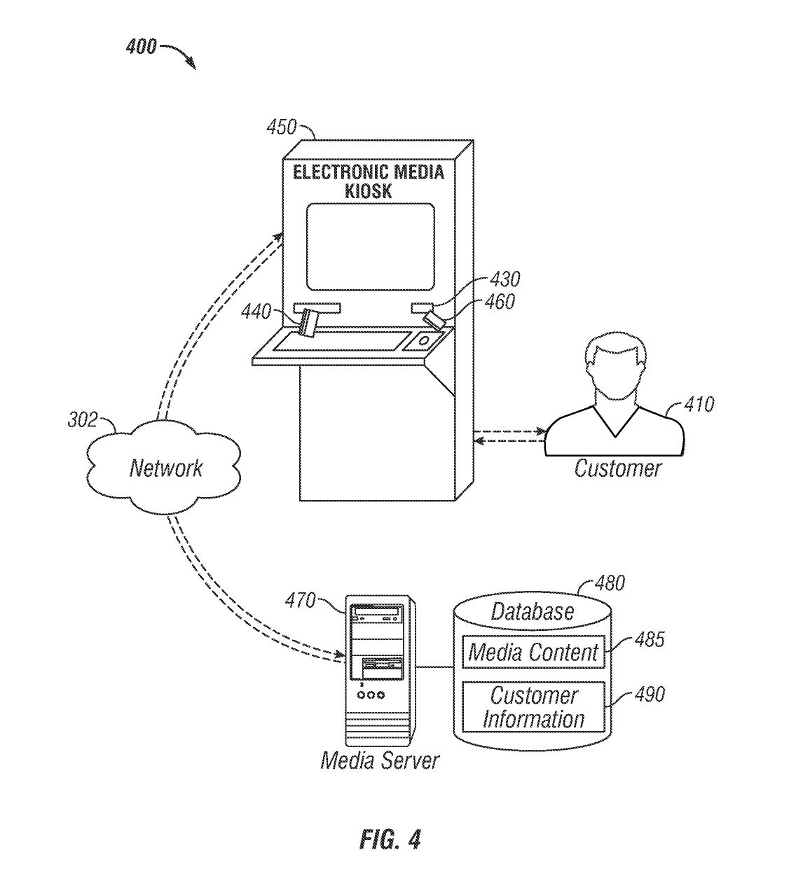

FIG. 4 illustrates a block diagram of a media distribution system 400 associated with an electronic kiosk 450, in accordance with the disclosed embodiments. Note that in FIGS. 1-6, identical or similar blocks are generally indicated by identical reference numerals. The media distribution system 400 can be configured to include the electronic kiosk 450 in association with a media server 470 and a database 480. The system 400 can be employed to deliver and transmit one or more digital media contents 485 for retail distribution via the electronic kiosk 450. The electronic kiosk 450 can be accessed for fee-based acquisition (purchase, rental, subscription, pay-per-view, etc.) of the media content 485 by a customer 410.

Note that the media kiosk 450 can act as a customer access point adapted for selection and transfer of the media contents 485 to a portable handheld device 460. The media kiosk 450 can be located at convenient locations such as airports, train stations, shopping centers, movie theatre, etc. The media kiosk 450 can be implemented so as to have a physical point-of presence that is discernable to the customer 410 (e.g., physical kiosks) or as virtual kiosks 450 that the customer 410 interacts with solely by way of screen images appearing on the handheld devices 460. Physical kiosks 450 can have any desired size, shape or configuration that is sufficient to facilitate public customer access. Exemplary configurations include automated teller machine designs, vending machine designs, booth designs, and cubicle designs, stall designs, stand designs, pavilion designs, counter designs, and store front designs, etc. Such media kiosks 450 can be operated with or without a sales attendant.

The kiosk 450 can be directly accessed via the portable handheld device 460 in order to download the digital media content 485. The portable handheld device 460 can be, for example, zip drive, USB device, portable media storage and playback device (e.g., an IPOD® device), mobile communication device such as blackberry, and iPhone, depending upon design considerations. The network 302 can be implemented to connect the kiosk 450 to the media server 470. The network 302 also facilitates electronic communication between the kiosk 450 and the customer handheld device 460, Network interconnectivity can be provided by a network hub, switch, router, or other kiosk communication interface,

The media kiosk 450 can include a communication interface 430 that include conventional network plug-in jacks in order to connect the handheld device 460 to the media kiosk 450. Alternatively, the communication interface 430 can provide wireless network support so that the handheld device 460 can communicate with the kiosk 450 by way of an air interface. Conventional network communication logic associate with the communication interface 430 can be employed to establish communication between the kiosk 450 and the handheld device 460. Customer device communication can also be implemented using the USB 111 or fire wire hub for directly attaching the handheld device 460 to the application server proxy or other kiosk computer.

The media server 470 monitors the operations of the media kiosk 450 and acts as a source of the media content 485 thereto. The media server 470 permits new media contents 485 to be easily downloaded by the customer 410 accessing the kiosk 450 via the network 302 as such content becomes available for release. The media server 470 can be optional, for example, in point-of-sale systems as the kiosk 450 can be operated as stand-alone entity if desired. The payment with respect to the downloaded media content 485 can be made via the electronically readable card 440 associated with an RFID tag. The payment can be also made via a pre-existing online account. Upon payment the media kiosk 450 releases the media content 485 to the portable handheld device 460. The media contents 485 discussed herein can be, for example, but not limited to, movies, music, games, computer software, and any type of voice or narration. The rental media content 485 obtained from the media kiosk 450 can be automatically deleted from the handheld device 460 and restocked to the kiosk 450 on expiry of a prescribed time period.

The system 400 can accept wide range of preferences regarding the time of delivery of the media content 485 to customers 410. The media content 485 that has not yet been released for sale or rental can be pre-ordered so that the media content 485 can be purchased and delivered to the customer once the media content 485 becomes available. The pre-ordered media contents 485 can be re-deemed to the customer 410 via an Internet code or can be mailed on a DVD to the home address of the customer 410. For example, a DVD copy of a movie can be preordered by the customer 410 immediately after leaving the movie theater. The pre-ordered media content can be further redeemed to the customer after expiry of certain time period (e.g., after 3 months when movie released) in order to prevent media piracy. Optional discount can also be provided for early purchase and the media content transmitted ahead of release date.

FIG. 5 illustrates a block diagram of the media distribution system 400, in accordance with the disclosed embodiments. The electronic media kiosk 450 can include the media data transmission module 152 that includes a financial transaction module 510, a media content selection module 520, and a media library 550. The media server 470 can include a financial transaction processor 560, a media content delivery module 570, and a database 480 that includes the media contents 485 and customer database information 490. The media library 550 associated with the media kiosk 450 can include the media contents 485 that are retrieved from the database 480 associated with the media server 470. The media contents 485 in the media library 550 can be in machine-readable format.

The multimedia library 550 can be accessible by the media server 470 associated with the database 480, which provides sort-query logic for searching and selecting the library contents. The media server 470 also implements content-downloading logic adapted to download media contents from the database 480 in order to upload purchased media content to the customers 410. As an alternative to locally stored media library 550 at each kiosk 450, a global multimedia library can be maintained in the media server 470 that can be employed to satisfy content upload requests from the customer 410.

The media content selection module 520 enables the customer 410 to browse or search the catalogs of contents and to select the media content 485. The media content selection module 520 then builds a list of contents 485 to be transferred to the handheld device 460 of the customer 410. The media content selection module 520 further prompts the customer 410 for selection of options based on other user selection such as, for example, but are not limited to, movie format, resolution, languages, and second session versions, etc. The media content selection module 520 determines whether the selected media contents 485 are stored locally in the media library 550 or required to be retrieved from the remote database 480. For remotely stored contents 485, the media content selection module 520 further requests the contents 485 from the database 480 via the media content delivery module 570 associated with the media server 470. The media content selection module 520 caches retrieved contents 485 for a period of time based on the popularity of the content 485.

The customer 410 also provides identification information for identifying the customer 410 to the media content selection module 520. The media content selection module 520 transmits the identification information to the database 480 associated with the remote server 470 through the network connection and receives customer information 490 from the media content delivery unit 570 of the remote media server 470. The customer information 490 reflects characteristics supplied by the customer 410 or derived based on customer activity such as past purchases. The media content selection module 520 can use the customer information 490 to suggest or select options and promotional contents for the customer 410.

The customer 410 can select and confirm the media contents 485 to be added to the handheld device 460. The media content 485 that has not yet been released for sale or rental can also be pre-ordered with respect to the electronic kiosk 450. The financial transaction module 510 then determines the cumulative cost of the selected contents 485. When the customer 410 is done adding and selecting the contents 485, the financial transaction module 510 displays a payment interface showing the total cost and payment options (e.g., cash, credit or bank card, online account, etc.) to the customer 410.

The customer 410 selects a payment mode and provides the appropriate payment, for example, by inserting a credit card. If the customer 410 selects a payment mode requiring external authorization, the financial transaction module 510 employs the financial transaction processor 560 associated with the remote media server 470 to verify with the appropriate authorizing institution to confirm the purchase of the customer 410. The media data transmission system 400 also includes a media content authorizing unit 530, an encryption unit 535, and a media writer 540. Varying units 530, 535, 540 described herein can be configured in hardware, software, or combination of hardware and software. The media data transmission system 400 can be configured to format, encode, encrypt, and write data to the handheld device 460 associated with the customer 410.

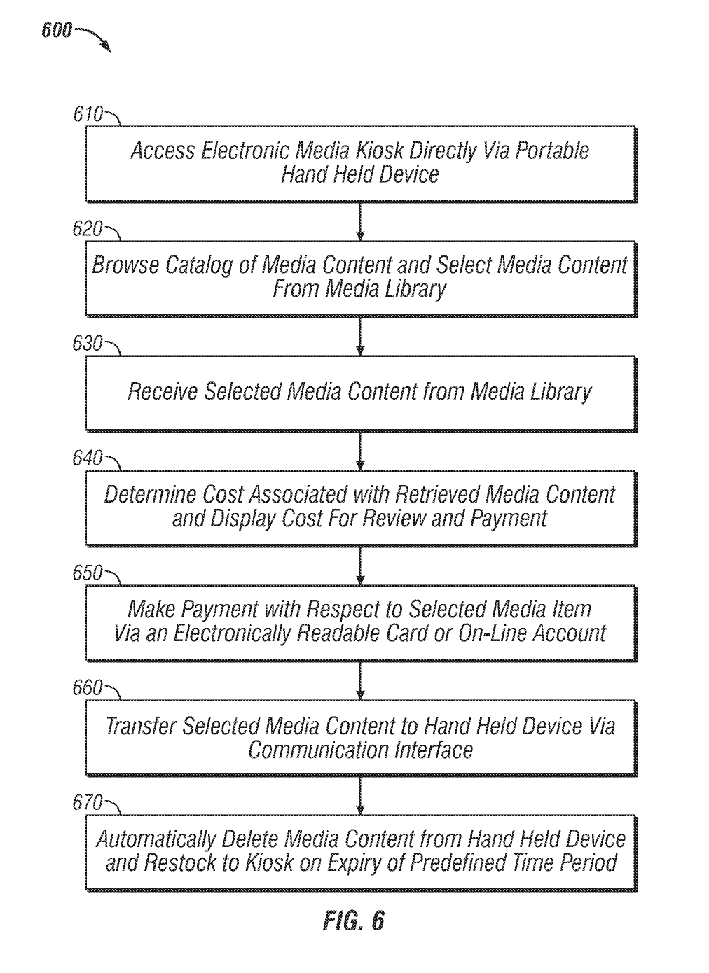

FIG. 6 illustrates a high level flow chart of operation illustrating logical operational steps of a method 600 for delivering and transmitting media contents 485 with respect to the media kiosk 450, in accordance with the disclosed embodiments. The media kiosk 450 can be accessed directly via the portable handheld device 460, as illustrated at block 610. The media contents 485 that are cataloged in the media library 550 associated with the media kiosk 450 can be selected, as indicated at block 620. The media contents 485 can be retrieved from the media library 450, as indicated at block 630. The media content 485 that has not yet been released for sale or rental can be pre-ordered so that the media content 485 can be purchased and delivered to the customer once the media content 485 becomes available. Optional discount can also be provided for early purchase and the media content 485 transmitted ahead of release date. The cost associated with the retrieved media content 485 can be determined and displayed to a customer for review and payment, as illustrated at block 640.

The payment with respect to the selected media contents 485 can be made via a credit card or pre-existing on-line account, as depicted at block 650. The selected media content 485 can be further transferred to the handheld device 460 associated with the customer 410 via the communication interface 430, as illustrated at block 660. The rental media content 485 obtained from the media kiosk 450 can be automatically deleted from the handheld device 460 and restocked to the kiosk 450 on expiry of a prescribed time period, as indicated at block 670. The system can therefore provide an individual customer 410 with access to a large number of media contents 485 in a convenient low-cost manner that fully satisfies the customer demand, while enhancing the economic incentives and creating an expanding offering of media contents to the customer.

Based on the foregoing, it can be appreciated that a number of embodiments are disclosed herein. For example, embodiments are disclosed of a method that includes directly accessing an electronic kiosk via a portable handheld device in order to select and transfer digital media content stored electronically in a database associated with the electronic kiosk; and processing payment with respect to the selected media content via at least one payment mode by a customer in order to thereafter transmit the media content to the portable handheld device.

The same or other embodiments of such a method can include determining a cost associated with the media content; and displaying the cost for review and payment by the customer. In still the same or other embodiments of such a method, an operation can be implemented for automatically deleting the media content from the portable handheld device in order to thereafter automatically restock the electronic kiosk with media content upon expiration of a predefined time period.

In yet the same or other embodiments of such a method, operations can be implemented for pre-ordering media content that has not been released for sale; and redeeming the media content by the customer after expiration of a certain time period in order to prevent media piracy. Additionally, in the same or other embodiments of such a method, an operation can be implemented for providing a discount for early purchase of the media content transmitted ahead of release date.

Also, in the same or other embodiments of such a method, operations can be implemented for configuring the electronic kiosk in association with a media server in order to communicate and monitor the media operation: and updating a media library associated with the media kiosk. Additionally, the aforementioned payment mode can be provided as payment modes such as, for example, but not limited to, an electronically readable card associated with an RFID tag and/or a pre-existing online account. Note that the aforementioned portable handheld device can be, for example, a zip drive and/or a universal serial bus storage device. The disclosed portable handheld device can also be, for example, a mobile communications device such as, for example, a Smartphone, etc.

In still other embodiments, a system can be implemented, which includes, for example, a processor; a data bus coupled to the processor; and a computer-usable medium embodying computer code, the computer-usable medium being coupled to the data bus. Such computer program code can include, for example, instructions executable by the processor and configured for: directly accessing an electronic kiosk via a portable handheld device in order to select and transfer digital media content stored electronically in a database associated with the electronic kiosk; and processing payment with respect to the selected media content via at least one payment mode by a customer in order to thereafter transmit the media content to the portable handheld device.

The customer can configure such instructions in the same or other embodiments for determining a cost associated with the media content; and displaying the cost for review and payment. Additionally, in the same or other embodiments of such a system, such instructions can be further configured for automatically deleting the media content from the portable handheld device in order to thereafter automatically restock the electronic kiosk with media content upon expiration of a predefined time period.

In yet the same or other embodiments of such a system, such instructions can be further configured for pre-ordering media content that has not been released for sale; and redeeming the media content by the customer after expiration of a certain time period in order to prevent media piracy. In still the same or other embodiments of such a system, such instructions can be further configured for providing a discount for early purchase of the media content transmitted ahead of release date. In yet the same or other embodiments of such a system, such instructions can be further modified for configuring the electronic kiosk in association with a media server in order to communicate and monitor the media operation; and updating a media library associated with the media kiosk.

Additionally, the aforementioned payment mode in such a system (or alternative embodiments thereof) can be, for example, an electronically readable card associated with an RFID tag. Such a payment mode can also be a preexisting online account, depending upon design goals and considerations with respect to varying embodiments. Additionally, the disclosed portable handheld device can be, for example, a zip drive, a universal serial bus storage drive, a mobile communications device such as a Smartphone, and so forth.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method, comprising:
accessing an electronic kiosk via a portable handheld device in order to select and transfer digital media content stored electronically in a database associated with said electronic kiosk: and
processing payment with respect to said selected media content via at least one payment mode by a customer in order to thereafter transmit said media content to said portable handheld device.

2. The method of claim 1 further comprising:
determining a cost associated with said media content; and
displaying said cost for review and payment by said customer.

3. The method of claim 1 further comprising automatically deleting said media content from said portable handheld device in order to thereafter automatically restock said electronic kiosk with media content upon expiration of a predefined time period.

4. The method of claim 1 further comprising:
pre-ordering media content that has not been released for sale; and
redeeming said media content by said customer after expiration of a certain time period in order to prevent media piracy.

5. The method of claim 4 further comprising providing a discount for early purchase of said media content transmitted ahead of release date.

6. The method of claim 1 further comprising:
configuring said electronic kiosk in association with a media server in order to communicate and monitor said media operation; and
updating a media library associated with said media kiosk.

7. The method of claim 1 wherein said payment mode comprises at least one of the following types of payment modes:
an electronically readable card associated with an RHO tag; or
a pre-existing online account.

8. The method of claim 1 further comprising configuring said portable handheld device to comprise a zip drive.

9. The method of claim 1 further comprising configuring said portable handheld device to comprise a universal serial bus storage device.

10. The method of claim 1 further comprising configuring said portable handheld device to comprise a mobile communications device.

11. A method, comprising:
directly accessing an electronic kiosk via a portable handheld device;
selecting digital media content stored electronically in a database associated with said electronic kiosk; and
processing payment with respect to said selected media content via at least one payment mode by a customer in order to thereafter transmit said media content to said portable handheld device.

12. The method of claim 11 further comprising transmitting said media content to said portable handheld device after processing said payment with respect to said selected media content.

13. The method of claim 12 further comprising:
determining a cost associated with said media content; and
displaying said cost for review and payment by said customer.

14. The method of claim 12 further comprising automatically deleting said media content from said portable handheld device in order to thereafter automatically restock said electronic kiosk with media content upon expiration of a predefined time period.

15. The method of claim 12 further comprising:
pre-ordering media content that has not been released for sale; and
redeeming said media content by said customer after expiration of a certain time period in order to prevent media piracy.

16. The method of claim 15 further comprising providing a discount for early purchase of said media content transmitted ahead of release date.

17. The method of claim 12 further comprising:
configuring said electronic kiosk in association with a media server in order to communicate and monitor said media operation; and
updating a media library associated with said media kiosk.

18. The method of claim 12 wherein said payment mode comprises at least one of the following types of payment modes:
an electronically readable card associated with RFID tag; or
a pre-existing online account.

19. The method of claim 12 further comprising configuring said portable handheld device to comprise a zip drive.

20. The method of claim 12 further comprising configuring said portable handheld device to comprise a universal serial bus storage device.

21. The method of claim 12 further comprising configuring said portable handheld device to comprise a mobile communications device.

22. A system, comprising:
a processor;
a data bus coupled to said processor; and
a computer-usable medium embodying computer code, said computer-usable medium being coupled to said data bus, said computer program code comprising instructions executable by said processor and configured for:
directly accessing an electronic kiosk via a portable handheld device in order to select and transfer digital media content stored electronically in a database associated with said electronic kiosk; and
processing payment with respect to said selected media content via at least one payment mode by a customer in order to thereafter transmit said media content to said portable handheld device.

23. The system of claim 22 wherein said instructions are further configured for:
determining a cost associated with said media content; and
displaying said cost for review and payment by said customer.

24. The system of claim 22 wherein said instructions are further configured for automatically deleting said media content from said portable handheld device in order to thereafter automatically restock said electronic kiosk with media content upon expiration of a predefined time period.

25. The system of claim 22 wherein said instructions are further configured for:
pre-ordering media content that has not been released for sale; and
redeeming said media content by said customer after expiration of a certain time period in order to prevent media piracy.

26. The system of claim 25 wherein said instructions are further configured for providing a discount for early purchase of said media content transmitted ahead of release date.

27. The system of claim 22 wherein said instructions are further configured for:
configuring said electronic kiosk in association with a media server in order to communicate and monitor said media operation; and
updating a media library associated with said media kiosk.

28. The system of claim 22 wherein said payment mode comprises an electronically readable card associated with an RFID tag.

29. The system of claim 22 wherein said payment mode comprises a preexisting online account.

30. The system of claim 22 wherein said portable handheld device comprises a zip drive.

31. The system of claim 22 wherein said portable handheld device comprises a universal serial bus storage device.

32. The system of claim 22 wherein said portable handheld device comprises a mobile communications device.

33. A system, comprising:
a processor;
a data bus coupled to said processor; and
a computer-usable medium embodying computer code, said computer-usable medium being coupled to said data bus, said computer program code comprising instructions executable by said processor and configured for:
directly accessing an electronic kiosk via a portable handheld device in order to select and transfer digital media content stored electronically in a database associated with said electronic kiosk;
processing payment with respect to said selected media content via at least one payment mode by a customer in order to thereafter transmit said media content to said portable handheld device;
determining a cost associated with said media content; and
displaying said cost for review and payment by said customer.
